(19) United States
(12) Patent Application Publication
(10) Pub. No.: US 2022/0169450 A1
(43) Pub. Date: Jun. 2, 2022

(54) SYSTEM AND METHOD FOR PARCEL ACCUMULATION AND NORMALIZATION

(71) Applicant: Siemens Logistics LLC, DFW Airport, TX (US)

(72) Inventors: Francisco Grupp, Trophy Club, TX (US); Michael D. Carpenter, Arlington, TX (US); John M. Zatopek, Arlington, TX (US)

(21) Appl. No.: 17/598,486

(22) PCT Filed: Apr. 25, 2019
(86) PCT No.: PCT/US2019/029041

§ 371 Date: Sep. 27, 2021

(51) Int. Cl. B65G 43/08; B65G 43/10; B65G 47/31

(52) U.S. Cl. CPC B65G 43/08; B65G 43/10; B65G 47/31; B65G 2203/042; B65G 2203/0241; B65G 2203/0291; B65G 2203/041; B65G 2201/0285

(57) ABSTRACT

A parcel processing system and related process. The parcel processing system includes a bulk transport conveyor (702), a multi-stage bulk transport accumulator (701), a singulator (710), and a control system. A process includes receiving a bulk flow of parcels (720) at a bulk transport conveyor (702) to be transported from the bulk transport conveyor (702) through a multi-stage bulk transport accumulator (701) to a singulator (710), determining a speed setting of the singulator (710), operating a first stage (708) of the multi-stage bulk transport accumulator (701) according to the speed setting of the singulator (710), operating a second stage (706) of the multi-stage bulk transport accumulator (701) according to a fill state of the first stage (708) of the multi-stage bulk transport accumulator (701), and operating the bulk transport conveyor (702) according to a fill state of the immediate downstream stage of the multi-stage bulk transport accumulator (701).

### TECHNICAL FIELD

Aspects of the present invention generally relate to a parcel management and transportation system and a method.

### BACKGROUND OF THE DISCLOSURE

At various stages of parcel processing, the incoming stream of parcels must be, at various times, processed in a “bulk” stream and processed in a singulated stream. Improved systems for more efficient singulation or accumulation are desirable.

### SUMMARY OF THE DISCLOSURE

Various disclosed embodiments include parcel processing system and related process and computer-readable medium. The parcel processing system includes a bulk transport conveyor, a multi-stage bulk transport accumulator, a singulator, and a control system.

A process includes receiving a bulk flow of parcels at a bulk transport conveyor to be transported from the bulk transport conveyor through a multi-stage bulk transport accumulator to a singulator, determining a speed setting of the singulator, operating a first stage of the multi-stage bulk transport accumulator according to the speed setting of the singulator, operating a second stage of the multi-stage bulk transport accumulator according to a fill state of the first stage of the multi-stage bulk transport accumulator, and operating the bulk transport conveyor according to a fill state of the immediate downstream stage of the multi-stage bulk transport accumulator.

Various embodiments also include monitoring a fill sensor that determines the fill state of the first stage of the multi-stage bulk transport accumulator. In various embodiments, the fill state indicates that that the first stage is full of parcels. or that the parcels on that stage of the multi-stage bulk transport accumulator have met a pre-determined capacity level of that stage of the multi-stage bulk transport accumulator. In various embodiments, the fill state indicates that the parcels on the first stage have met a pre-determined capacity level of the first stage. In various embodiments, operating the second stage according to the fill state of the first stage includes operating the second stage at a predetermined speed when the fill state is that that a predetermined capacity level has not been met. In various embodiments, operating the second stage according to the fill state of the first stage includes include stopping the second stage when the fill state is that that a predetermined capacity level has been met. Various embodiments also include operating other stages of the multi-stage bulk transport accumulator each according to a fill state of an immediate downstream stage of the multi-stage bulk transport accumulator. In various embodiments, operating second stage is performed by controlling the speed of a metered accumulator discharge the second stage. In various embodiments, at least one of the first stage or the second stage includes a transport surface comprising a plurality of modular conveyor units.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of parcel processing stages;

FIG. 2 illustrates the influence of parcel size on the bandwidth of a sliding shoe sorter device;

FIG. 3 illustrates the effect of mismatching rate to the dynamic processing rate limitation, resulting in reduced productivity;

FIG. 4 illustrates a function of the inline accumulator at the input of the singulator in accordance with disclosed embodiments.

FIG. 5 illustrates an example of a modular conveyor unit in accordance with disclosed embodiments.

FIGS. 6A and 6B illustrate an example of a top view and a side view of a bulk transport accumulator in accordance with disclosed embodiments;

FIG. 7 illustrates an implementation example of a bulk transport accumulator using three stages of inline accumulation of a multi-stage bulk transport accumulator in advance of a singulator, in accordance with disclosed embodiments;

FIG. 8 illustrates a flowchart of a process in accordance with disclosed embodiments;

FIG. 9 illustrates a block diagram of a data processing system 900 with which an embodiment can be implemented, for example as control system in accordance with disclosed embodiments.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In parcel processing operations, a processing facility performs consolidation and fragmentation of bulk volumes of parcels. Within this process, consolidation represents aggregating an amalgam of parcels with a plurality of destinations, typically for the purpose of shipping/transfer between processing facilities within a shipping network, while fragmentation represents sorting the parcels per common destinations within the network, such as for sorting to downstream facilities within the network and/or to final delivery points.

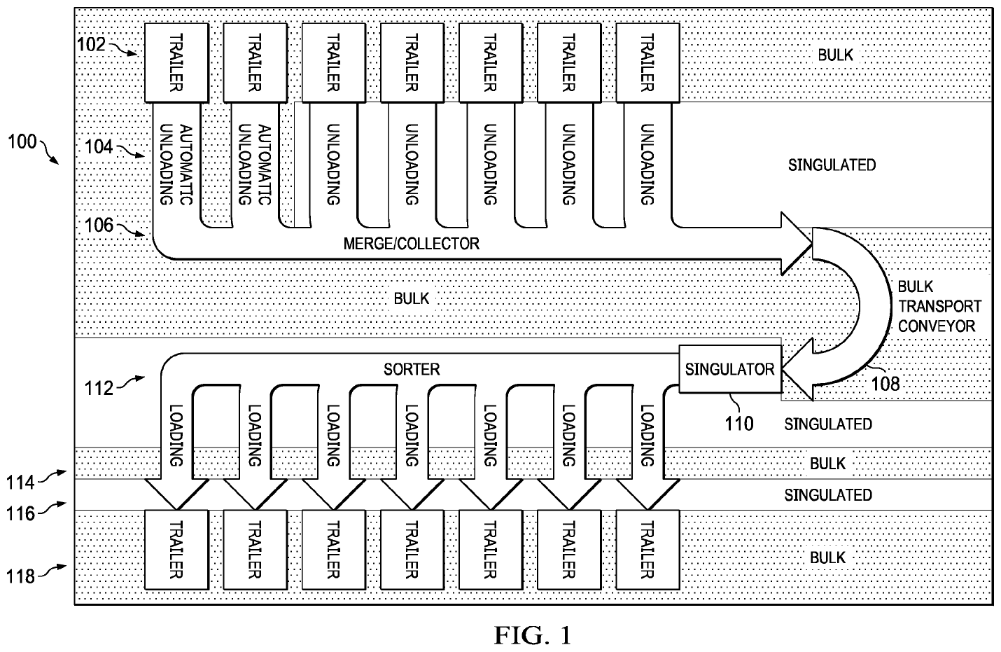

FIG. 1 illustrates an example of parcel processing stages within a facility 100, where the parcels that are unloaded are merged into an essentially consolidated flow, then fragmented by parcel sorting to parcel loading into individual trailers with specific destinations.

In this example, parcels are transported or stored in bulk in container/trailer 102. During unloading 104, whether manual or automatic, the parcels are largely singulated. The singulated parcel flows from each container are merged/collected 106, which produces a bulk flow, which is transported on bulk transport conveyor 108. This bulk from is singulated again at singulator 110 for sorting 112. After sorting, the sorted parcels are again in a bulk collection at sorting output 114 (and any related transport). The process of loading the sorted bulk parcels at 116 again largely singulates them, where they are collected in bulk in container/trailer 118.

In reality, a process as reflected in the example of FIG. 1 is very complex, including multiple sorting steps and loading for delivery, but this simplified perspective faithfully illustrates factors affecting the problem.

Within the overall process, the parcels remain comingled in a bulk state whenever possible. This improves efficiency but has the effect of requiring singulation from the bulk flow when the parcels must be handled individually, as in the unloading, sorting, and loading steps.

Ideally, the processing rates of input (unloading), of sorting (including input singulation), and of loading are balanced so that across the overall process, each step would run at a steady, optimal rate. This allows staffing from end to end to be optimized in terms of productivity.

In reality, however, all elements of the overall process are highly dynamic and affected by different factors so that variations in processing rate are seldom synchronized. Further, certain elements are highly sensitive to over-provisioning (exceeding the dynamic rate limitation), which reduces productivity.

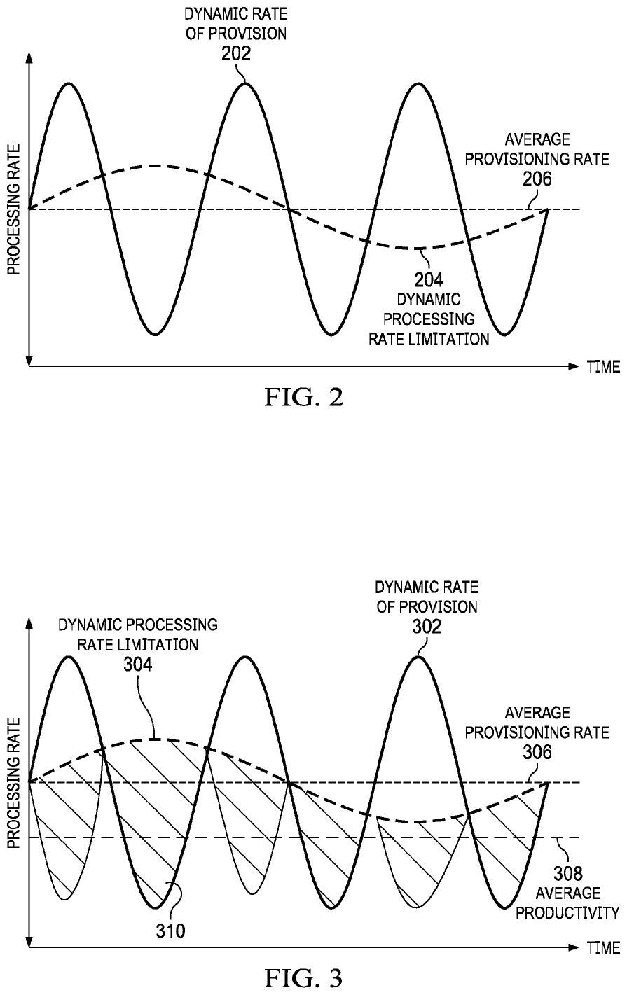

FIG. 2 illustrates the influence of parcel size on the bandwidth of a sliding shoe sorter device. When the dynamic phases of provision 202 exceed the dynamic processing rate limitation 204, all the items processed typically create exceptions, resulting in non-productive processing. In this example, the average provisioning rate 206 remains substantially constant. While, in this example, symmetrical sine waves for the dynamic phases of provision 202 and the dynamic processing rate limitation 204 are shown to explain the principal, the fluctuations in provisioning are actually unpredictable within the constraints of the flow capacity of a typical bulk transport conveyor. Similarly, the processing rate limitation is unpredictable within fundamental constraints.

FIG. 3 illustrates the effect of mismatching rate to the dynamic processing rate limitation, resulting in reduced productivity. When dynamic phases of provision are inadequate to the dynamic processing rate limitation, productivity is also lost. In this figure, the average provisioning rate 306 remains substantially constant. Area 310 illustrates the lost productivity where the dynamic phases of provision 302 are less than the dynamic processing rate limitation 304, resulting in a much lower average productivity 308 than the average provisioning rate 306.

Both over- and under-provisioning have the effect of reducing productivity, which results in failure of related systems to capture the planned value. The customer's return on investment is far less than the potential for the equipment.

In addition, the system provides little useful feedback in efforts to manage the provisioning operation to optimize productivity while not exceeding the dynamic processing rate limitation. For example, if an operator sees that the singulator does not have sufficient volume to reach the dynamic processing rate limitation, a radio call to the unloading operation is more likely to cause a problem at the singulator than improve the immediate situation.

One approach to addressing this problem involves dynamically adjusting the speed of bulk transport conveyor 108 illustrated in the example of FIG. 1. This technical approach, referred to as “upstream controls,” essentially puts the arcuate portion of bulk transport conveyor 108 under control of the singulator.

The premise of this approach is that when the singulator is being over provisioned, it can dynamically reduce the rate of provision, thereby preventing the rate of provision from exceeding the dynamic processing rate limitation.

Drawbacks to this approach are that the disparity in the processing rate is not eliminated, but rather is moved upstream to the boundary of upstream controls, where piles of parcels are created. Further, this approach does nothing for under-provisioning, so that productivity fluctuations below the dynamic processing rate limitation still detract from the potential value of the system. Ultimately, the approach fails because the bulk transport conveyor is populated by an unevenly distributed, unknown number of parcels in unknown positions.

Disclosed embodiments provide systems and methods for improving control of the parcel processing system using additional sensor feedback to determine the state of the system. Disclosed embodiments provide an awareness of the detailed density of the conveyor immediately upstream of the singulator and implement dynamic control of the conveyor systems. In various embodiments, the system improves processing by making the parcel density predictable during processing.

Disclosed embodiments provide a specialized, automatic, inline accumulating system that maintains high density on the conveyor directly upstream of the singulator, and therefore makes the parcel processing not only predictable, but optimal. Disclosed embodiments smooth the dynamic rates of provision to more closely conform to the dynamic processing rate limitation.

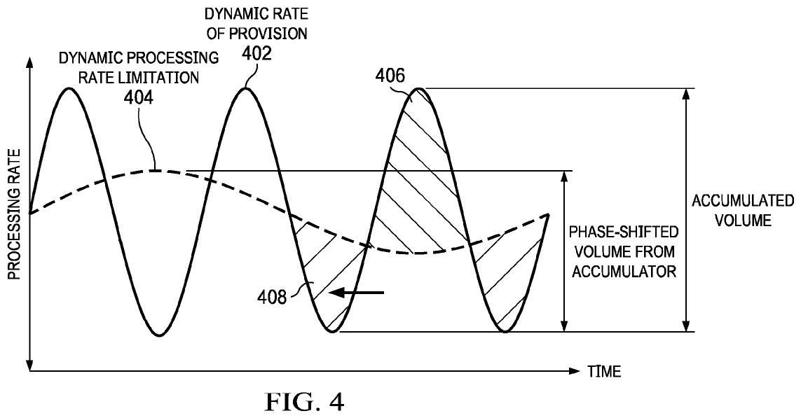

FIG. 4 illustrates a function of the inline accumulator at the input of the singulator. In this figure, the original dynamic provisioning rate average provisioning rate 302 again occasionally exceeds or is less than the dynamic processing rate limitation 404. However, as shown on the right side of this figure, disclosed embodiments accomplish a phase-shifting of the provisioning from the accumulator, so the parcel volume 406 that would have exceeded the dynamic processing rate limitation 404 is instead moved shifted to occupy available capacity 408 where the unshifted dynamic provisioning would have been less than the dynamic processing rate limitation 404.

Disclosed embodiments can be implemented using various accumulating methods, such as configurations of cascade and chute, or of inclined gravity conveyors. This invention is based on segments of inline gravity conveyor, with a novel approach to controlling the accumulator drain, and a novel means of providing actionable feedback to manage the unloading operation.

Some conveyor systems use modular plastic conveyor units with free-running roller features distributed across the transport surface. The orientation of the roller features about the longitudinal axis may be angled to change the steering of items being conveyed.

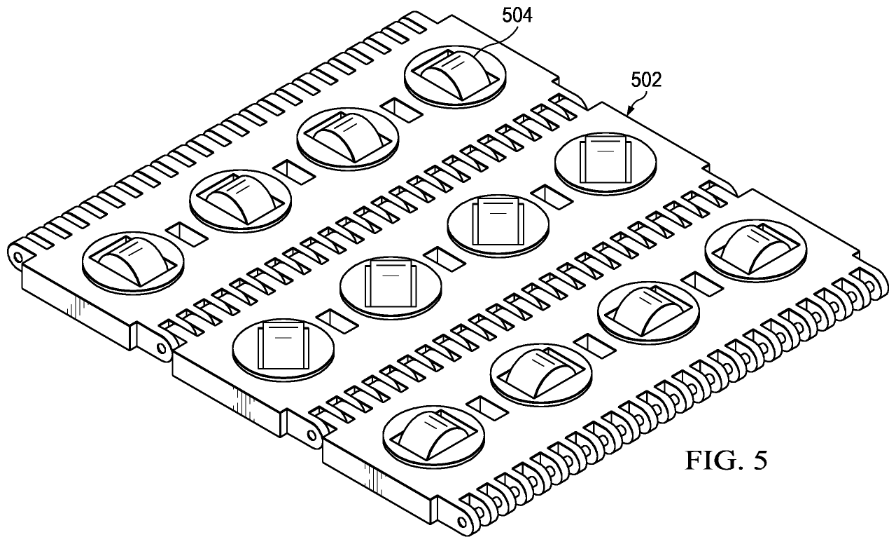

FIG. 5 illustrates an example of a modular conveyor unit 502 with a plurality of wheels 504 that can be driven or free-rolling. Wheels 504 can be controlled to present different angles of travel. In various embodiments, a conveying surface is comprised on one or more modular conveyor units 502, and each modular conveyor unit 502 is stationary, establishing a plane installed at an angle so that articles roll “downhill’ on the surfaces of the individual rollers.

Traditional gravity conveyors rely on free-turning rollers extending across a conveyor installed at an incline. One advantage of a modular conveyor unit 502 is that the rolling surface across the conveyor is composed of independent rolling elements, which allows adjacent items across the conveyor to move freely, whereas a stationary item on a longer roller would hold the roller and any other items coming into contact with that roller stationary.

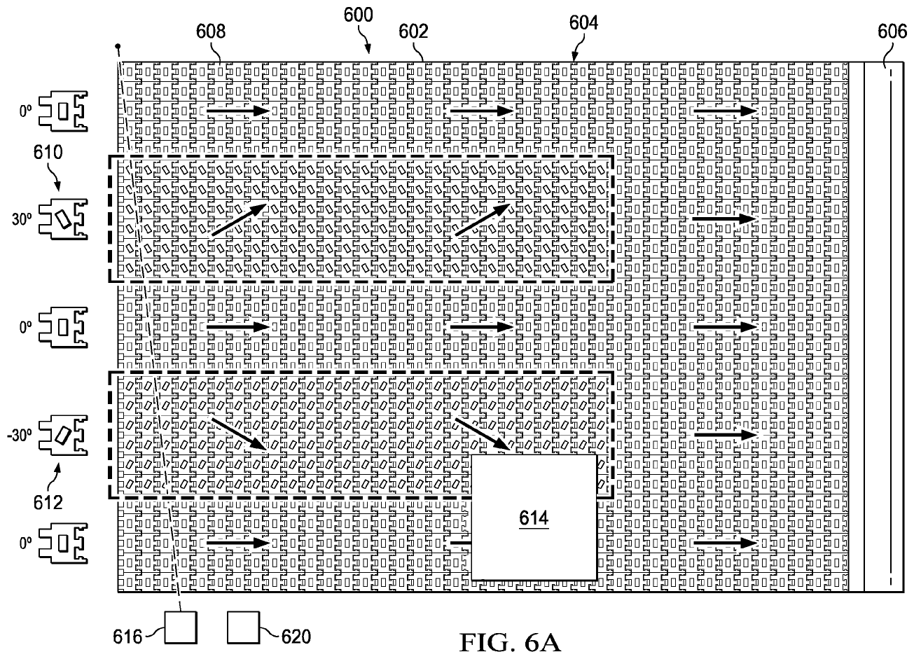

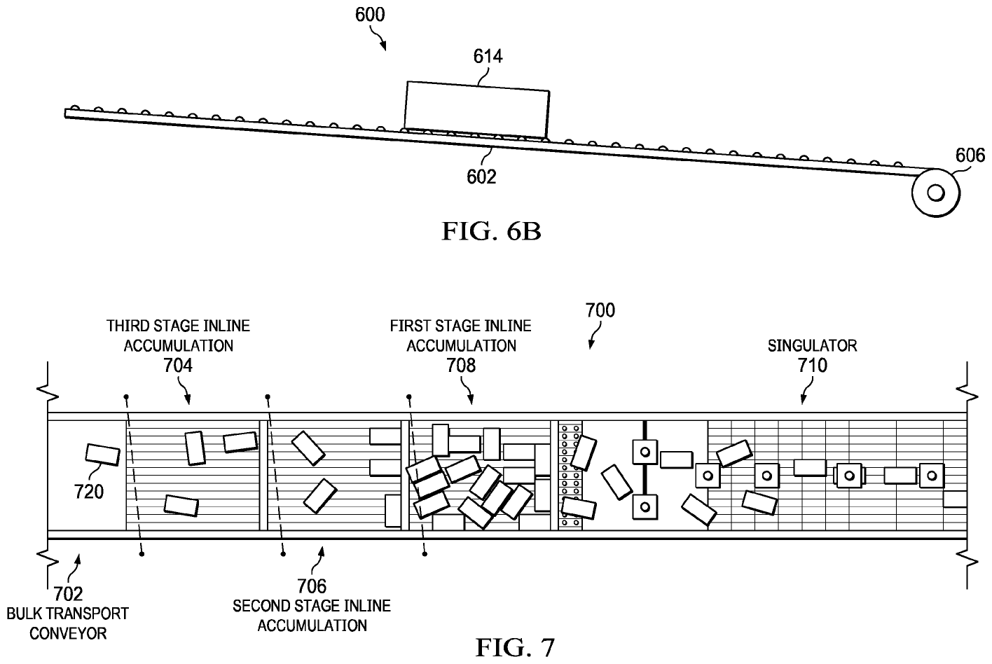

FIG. 6A illustrates an example of a top view of a bulk transport accumulator 600 in accordance with disclosed embodiments. Bulk transport accumulator 600 has an inclined transfer surface 602 implemented using one or more modular conveyor units 604. That is, the inclined transfer surface is comprised of a field of directionally-controlled, driven or free-rolling rollers, which may be part of a single conveyor unit 604 or may be implemented by a set of modular conveyor units 604 controlled together. The arrows indicate the generally left-to-right flow of parcels down the inclined transfer surface 602.

Each element of bulk transport accumulator 600 can be connected to be controlled by control system 620, which may be part of any overall control system for the parcel processing system.

According to disclosed embodiments, a metered accumulator discharge 606 can positioned along the lower edge of the inclined plane of individual rollers. The metered accumulator discharge 606 can be implemented, for example, as a raised, high friction, dynamically-controlled powered roller. Alternatively, and depending on the surface area required in high friction to meter the parcels accumulated on the incline, the metered accumulator discharge 606 can be implemented as a high friction, dynamically-controlled driven belt.

The individual rollers 608 of the inclined transfer surface 602 may be angled in certain areas to improve distribution of items across the surface of the plane, particularly in the first inline segment. When there are multiple segments, the spreading function may not be needed on every segment. In this example, the rollers in area 610 are controlled to be angled at 300 left with respect to the direction of travel, causing parcels to move to the left side of inclined transfer surface 602 as they cross the bulk transport accumulator 600. Similarly, the rollers in area 612 are controlled to be angled at 30° right with respect to the direction of travel, causing parcels 614 to move to the right side of inclined transfer surface 602 as they cross the bulk transport accumulator 600.

Bulk transport accumulator 600, in this example, include a sensor 616, such as a look-across photocell, LIDAR, machine vision camera, or other sensor that is configured to detect parcels 614 at or near the top of the inclined transfer surface 602. Bulk transport accumulator 600 can include multiple other sensors 616 or other sensors along the inclined transfer surface 602 to be able to detect a “fill state” of accumulated parcels at any time.

FIG. 6B illustrates an example of a side view of bulk transport accumulator 600 in accordance with disclosed embodiments. Bulk transport accumulator 600 has an inclined transfer surface 602 that transport parcels 614 to metered accumulator discharge 606.

Multiple factors can influence the angle of the inclined transfer surface 602 and its length in the transport direction, including the range of size and weight of the parcels being processed, the speed required in flow-through to meet the highest speed allowed by the metered accumulator discharge 606 (“MAD”), and any limitations based on parcel crushing due to line pressure of accumulated parcels at incline. The speed of accumulated parcels is preferably equal to the speed of the MAD.

The high-level function of controlling the bulk transport accumulator can be simply expressed as accumulating surges in dynamic provision that exceed the dynamic processing rate of the singulator, and alternatively, incrementally discharging the accumulated surge during periods when the dynamic provision rate is inadequate to meet the dynamic processing rate (as illustrated in the example of FIG. 4). This is achieved by monitoring sensors 616 to determine the fill state of each bulk transport accumulator to receive sensor inputs and using those sensor inputs to control the different MADs.

To determine that a stage of inline accumulation is full, a de-bounce processing can be used as necessary to differentiate between transient blocking (caused by a parcel being conveyed through the photocell at transport speed) and the blocking that occurs with stationary items.

FIG. 7 illustrates an implementation example of parcel processing system 700 including a bulk transport accumulator 701 using three stages of inline accumulation of a multi-stage bulk transport accumulator 701 in advance of a singulator. This example shows modular inline accumulation with dual look-across sensors. In this example, parcels 720 are transported on a bulk transport conveyor to third stage bulk transport accumulator 704, second stage bulk transport accumulator 706, first stage bulk transport accumulator 708, and finally to singulator 710.

The metered accumulator discharge of each bulk transport accumulator 704/706/708 is controlled by the control system according to the state of downstream devices.

While disclosed embodiments contemplate a single-stage accumulator, a multi-stage accumulator as disclosed herein allows the accumulation capacity to be modular, to accommodate both applications that have a highly dynamic rate of provision and application that are less dynamic. Line pressure, which is caused by the accumulated mass on the gravity incline, can be great enough in single-stage accumulators to damage items or overcome the metering device. Since the mass of buffered parcels increases pressure on the MAD, providing multiple stages of limited length prevents the accumulation pressure from either damaging items at the MAD or pushing through the MAD.

The first stage inline accumulator 708 MAD is controlled according to the state of the singulator 710. In one exemplary implementation, the input of the singulator 710 can be operated at 32 speeds, including stopped. In this example, the speed of the first stage inline accumulator 708 MAD can be controlled according to the speed setting of the singulator 710 input.

The second stage inline accumulation 706 MAD is controlled by monitoring the look-across photocell in the first stage inline accumulation 708 to detect that the first stage inline accumulation 708 is at capacity. When the accumulation is full, the MAD is stopped, otherwise the MAD operates at the target speed.

The third stage inline accumulation 704 MAD is controlled by monitoring the look-across photocell in the second stage inline accumulation 706 to detect that the second stage inline accumulation 706 is at capacity. When the accumulation is full, this MAD is stopped, otherwise the MAD operates at the target speed.

The bulk transport conveyor 702 is controlled by monitoring the look-across photocell in the third stage inline accumulation 704 to detect that the third stage inline accumulation 704 is at capacity. When the accumulation is full, the bulk transport conveyor 702 is stopped, otherwise the bulk transport conveyor operates at the target speed.

In this example, the control system is throttling the MAD of the first stage inline accumulation module 708 based on the requirements of singulator 710.

In the case of primary processing, the measured percentage of accumulator fill, e.g., 33% in this example, represents “dampened” feedback signal to the unloading operation, more suitable to use as a basis of managing unloading productivity than immediate impressions that the singulator has too much or not enough.

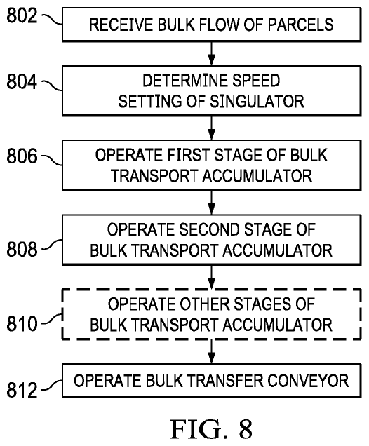

FIG. 8 illustrates a flowchart of a process in accordance with disclosed embodiments, as performed under the control of a control system of a parcel processing system including a bulk transport conveyor, a multi-stage bulk transport accumulator, and a singulator.

The parcel processing system receives a bulk flow of parcels at the bulk transport conveyor to be transported from the bulk transport conveyor through the multi-stage bulk transport accumulator to the singulator (802).

The parcel processing system determines a speed setting of the singulator (804). This can be performed by setting the speed setting of the singulator, receiving the speed setting from the singulator, receiving a configuration that includes the speed setting or otherwise.

The parcel processing system operates a first stage of the multi-stage bulk transport accumulator according to the speed setting of the singulator (806).

The parcel processing system operates a second stage of the multi-stage bulk transport accumulator according to a fill state of the first stage of the multi-stage bulk transport accumulator (808). In various embodiments, this can be accomplished by monitoring a fill sensor that determines the fill state of the first stage of the multi-stage bulk transport accumulator, such as using a look-across photocell, LIDAR, machine vision camera, or other sensor. The fill state can indicate that that stage of the multi-stage bulk transport accumulator is full of parcels or that the parcels on that stage of the multi-stage bulk transport accumulator have met a pre-determined capacity level of that stage of the multi-stage bulk transport accumulator. The parcel processing system can operate the second stage of the multi-stage bulk transport accumulator also according to other operating characteristics of the first stage of the multi-stage bulk transport accumulator, including its processing speed or other factors.

Operating the second stage of the multi-stage bulk transport accumulator according to a fill state of the first stage of the multi-stage bulk transport accumulator can include operating the second stage at a predetermined speed when the fill state is that that the predetermined-capacity level has not been met. Operating the second stage of the multi-stage bulk transport accumulator according to a fill state of the first stage of the multi-stage bulk transport accumulator can include stopping the second stage when the fill state is that that the predetermined-capacity level has been met.

The parcel processing system can then operate other stages of the multi-stage bulk transport accumulator according to a fill state of an immediate downstream stage of the multi-stage bulk transport accumulator (810). This process can be performed in the same manner as 808, where, for example, the operation of a third stage is according to the second stage, the operation of a fourth stage is according to the third stage, etc. Each stage can have a corresponding predetermined speed; for example, the first stage can have a first predetermined speed, the second stage can have a second predetermined speed, etc. “Other stages” refers to at least one other stage.

Operating each stage of the multi-stage bulk transport accumulator can by implemented by controlling the speed of a metered accumulator discharge of each stage. Each stage of the multi-stage bulk transport accumulator can be implemented as described herein.

The parcel processing system operates the bulk transport conveyor according to a fill state of the immediate downstream stage of the multi-stage bulk transport accumulator (812). This process can be performed in the same manner as 808, where the speed of the bulk transport conveyor is according to the fill state of the stage of the multi-stage bulk transport accumulator that it feeds.

By basing the operation state and/or speed of the bulk transport conveyor and each stage of the multi-stage bulk transport conveyor on the fill state of the immediate downstream device, the efficiency of the parcel processing system is improved and the parcel flow into the singulator is maximized.

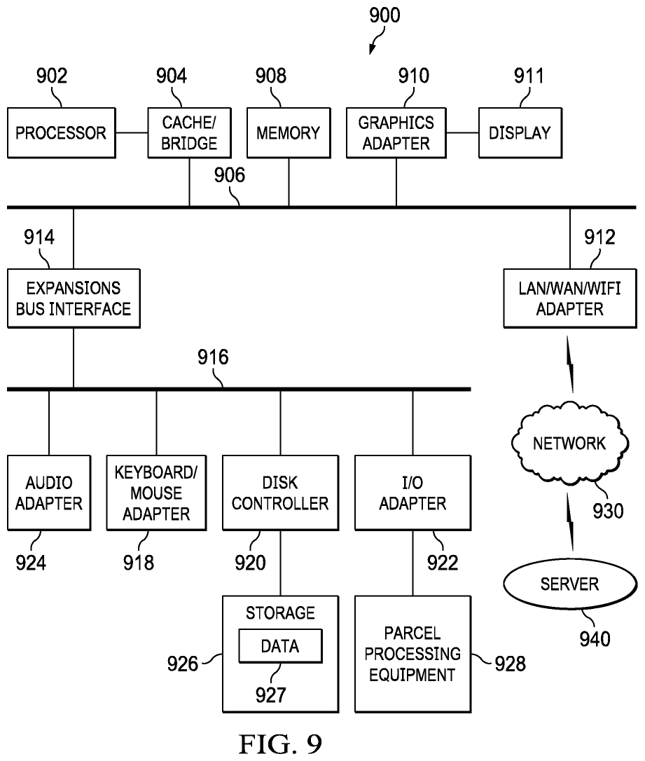

FIG. 9 illustrates a block diagram of a data processing system 900 with which an embodiment can be implemented, for example as control system or other device configured by software or otherwise to perform the processes as described herein, and in particular as each one of a plurality of interconnected and communicating systems as described herein. The exemplary, non-limiting data processing system 900 can be used, for example, as the control system of the parcel processing system and for controlling one or more of the transport, singulation, sorting, and other devices. The data processing system depicted includes a processor 902 connected to a level two cache/bridge 904, which is connected in turn to a local system bus 906. Local system bus 906 may be, for example, a peripheral component interconnect (PCI) architecture bus. Also connected to local system bus in the depicted example are a main memory 908 and a graphics adapter 910. The graphics adapter 910 may be connected to display 911.

Other peripherals, such as local area network (LAN)/Wide Area Network/Wireless (e.g. WiFi) adapter 912, may also be connected to local system bus 906. Expansion bus interface 914 connects local system bus 906 to input/output (I/O) bus 916. I/O bus 916 is connected to keyboard/mouse adapter 918, disk controller 920, and I/O adapter 922. Disk controller 920 can be connected to a storage 926, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 926 can store any data 927 useful in performing processes as described herein, including any executable instructions, statuses, signal input data, configuration data, sort data, processing rate data, or other data.

I/O adapter 922 is connected to control parcel processing equipment 928, which can be any of the elements illustrated in FIGS. 1-7.

Also connected to I/O bus 916 in the example shown is audio adapter 924, to which speakers (not shown) may be connected for playing sounds. Keyboard/mouse adapter 918 provides a connection for a pointing device (not shown), such as a mouse, trackball, trackpointer, touchscreen, etc.

Those of ordinary skill in the art will appreciate that the hardware depicted in FIG. 9 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™ a product of Microsoft Corporation located in Redmond, Wash. may be employed if suitably modified. The operating system is modified or created in accordance with the present disclosure as described.

LAN/WAN/Wireless adapter 912 can be connected to a network 930 (not a part of data processing system 900), which can be any public or private data processing system network or combination of networks, as known to those of skill in the art, including the Internet. Data processing system 900 can communicate over network 930 with server system 940, which is also not part of data processing system 900, but can be implemented, for example, as a separate data processing system 900. Data processing system 900 can communicate with other elements as disclosed herein, such as communications between the control system and each of the parcel processing devices or systems, communications with users, and other communications, whether wired or wireless.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

Note that portions of the overall control system of the parcel processing system need not be controlled by a central processor or controller but can be implemented using discrete circuits. For example, the stop/run operation of one stage of the multi-stage bulk transport accumulator could be directly circuit-controlled based on sensor inputs from the downstream stage.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form. In particular, the features and operations of various examples described herein and in the incorporated applications can be combined in any number of implementations.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

1. A parcel processing method, comprising:
receiving a bulk flow of parcels at a bulk transport conveyor to be transported from the bulk transport conveyor through a multi-stage bulk transport accumulator to a singulator;
determining a speed setting of the singulator;
operating a first stage of the multi-stage bulk transport accumulator according to the speed setting of the singulator;
operating a second stage of the multi-stage bulk transport accumulator according to a fill state of the first stage of the multi-stage bulk transport accumulator; and
operating the bulk transport conveyor according to a fill state of the immediate downstream stage of the multi-stage bulk transport accumulator.

2. The parcel processing method of claim 1, further comprising monitoring a fill sensor that determines the fill state of the first stage of the multi-stage bulk transport accumulator.

3. The parcel processing method of claim 1, wherein the fill state indicates that that the first stage is full of parcels or that the parcels on that stage of the multi-stage bulk transport accumulator have met a pre-determined capacity level of that stage of the multi-stage bulk transport accumulator.

4. The parcel processing method of claim 1, wherein the fill state indicates that the parcels on the first stage have met a pre-determined capacity level of the first stage.

5. The parcel processing method of claim 1, wherein operating the second stage according to the fill state of the first stage includes operating the second stage at a predetermined speed when the fill state is that that a predetermined capacity level has not been met.

6. The parcel processing method of claim 1, wherein operating the second stage according to the fill state of the first stage includes stopping the second stage when the fill state is that that a predetermined capacity level has been met.

7. The parcel processing method of claim 1, further comprising operating other stages of the multi-stage bulk transport accumulator each according to a fill state of an immediate downstream stage of the multi-stage bulk transport accumulator.

8. The parcel processing method of claim 1, wherein operating second stage is performed by controlling the speed of a metered accumulator discharge the second stage.

9. The parcel processing method of claim 1, wherein at least one of the first stage or the second stage includes a transport surface comprising a plurality of modular conveyor units.

10. A parcel processing system comprising:
a bulk transport conveyor configured to receive a bulk flow of parcels;
a multi-stage bulk transport accumulator configured to receive the bulk flow of parcels from the bulk transport conveyor; and
a singulator configured to receive the bulk flow of parcels from the multi-stage bulk transport accumulator; and
a control system configured to control the parcel processing system to perform a method as claimed in claim 1.

11. A non-transitory machine-readable medium storing executable instructions that, when executed, cause a control system of a parcel processing system to perform a method as claimed in claim 1.
